(19) United States
(12) Patent Application Publication
(10) Pub. No.: US 2022/0009061 A1
(43) Pub. Date: Jan. 13, 2022

(54) Pivoting Head Wrench Apparatus

(71) Applicants: Tony Payne, Yoakum, TX (US); Mickey Rauch, Yoakum, TX (US)

(72) Inventors: Tony Payne, Yoakum, TX (US); Mickey Rauch, Yoakum, TX (US)

(21) Appl. No.: 16/924,302

(22) Filed: Jul. 9, 2020

(51) Int. Cl. B25B 23/00; B25B 13/04; B25B 13/08

(52) U.S. Cl. CPC B25B 23/0028; B25B 13/481; B25B 13/08; B25B 13/04

(57) ABSTRACT

A pivoting head wrench apparatus for use in confined areas includes a handle having a handle top side, a handle bottom side, a handle first end, a handle second end, a handle front edge, and a handle back edge. A first wrench head is coupled to the handle. The first wrench head is pivotably coupled to the handle first end and is sized to a standard metric size. A second wrench head is coupled to the handle. The second wrench head is pivotably coupled to the handle second end and is sized to a standard SAE size.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wrench devices and more particularly pertains to a new wrench device for use in confined areas.

### (2) Description of Related Art Including Information Disclosed Under 37 CFR 1.97 and 1.98

The prior art relates to wrench devices. Existing devices may offer metric and SAE measurements on different heads of the same wrench, but do not have pivoting heads. Existing box head wrenches also do not have pivoting heads. These devices also lack integrated grip pads to increase user comfort and prevent slippage.

### BRIEF SUMMARY OF THE INVENTION

An embodiment of the disclosure meets the needs presented above by generally comprising a handle having a handle top side, a handle bottom side, a handle first end, a handle second end, a handle front edge, and a handle back edge. A first wrench head is coupled to the handle. The first wrench head is pivotably coupled to the handle first end and is sized to a standard metric size. A second wrench head is coupled to the handle. The second wrench head is pivotably coupled to the handle second end and is sized to a standard SAE size.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pivoting head wrench apparatus according to an embodiment of the disclosure.

FIG. 2 is a top plan view of an embodiment of the disclosure.

FIG. 3 is a side elevation view of an embodiment of the disclosure.

FIG. 4 is a bottom plan view of an embodiment of the disclosure.

FIG. 5 is an isometric view of an embodiment of the disclosure.

FIG. 6 is a top plan view of an embodiment of the disclosure.

FIG. 7 is a side elevation view of an embodiment of the disclosure.

FIG. 8 is a bottom plan view of an embodiment of the disclosure.

FIG. 9 is an isometric view of an embodiment of the disclosure.

FIG. 10 is a top plan view of an embodiment of the disclosure.

FIG. 11 is a side elevation view of an embodiment of the disclosure.

FIG. 12 is a bottom plan view of an embodiment of the disclosure.

### DETAILED DESCRIPTION OF THE INVENTION

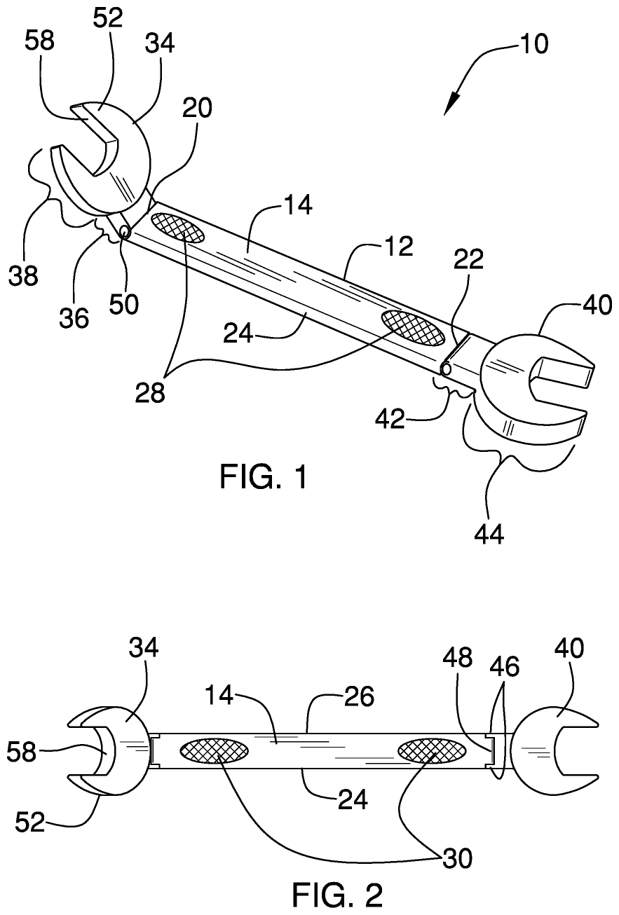

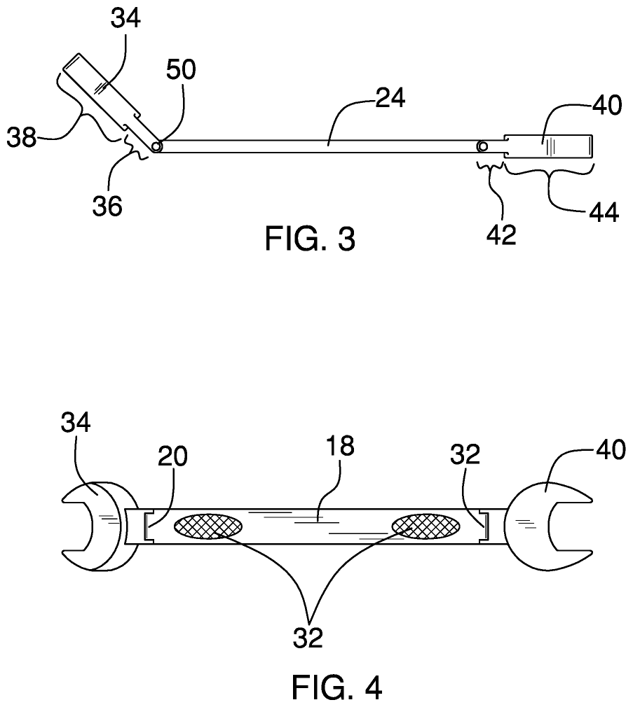

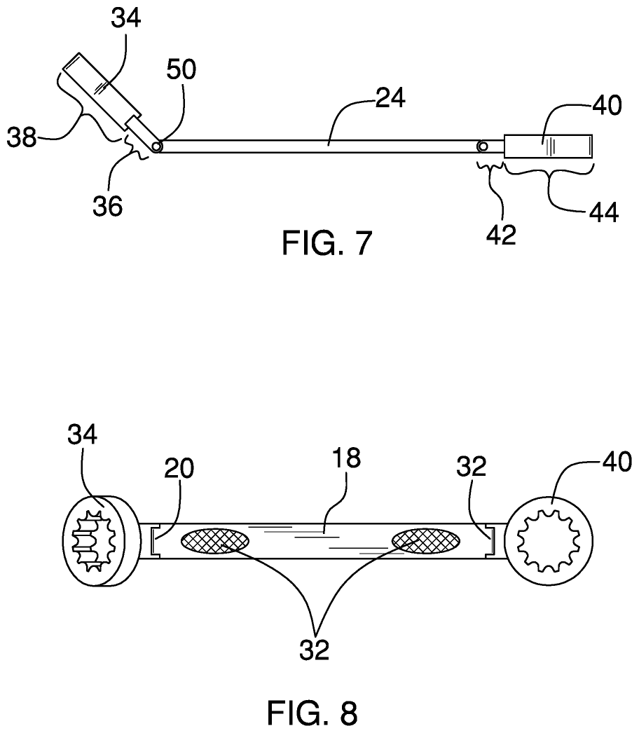

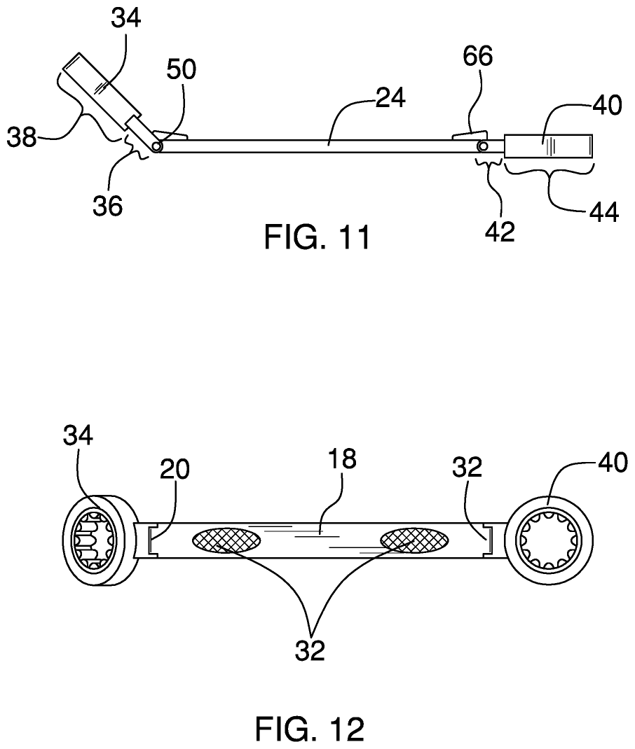

With reference now to the drawings, and in particular to FIGS. 1 through 12 thereof, a new wrench device embodying the principles and concepts of an embodiment of the disclosure and generally designated by the reference numeral 10 will be described.

As best illustrated in FIGS. 1 through 12, the pivoting head wrench apparatus 10 generally comprises a handle 14 having a handle top side 16, a handle bottom side 18, a handle first end 20, a handle second end 22, a handle front edge 24, and a handle back edge 26.

A plurality of grip pads 28 may be coupled to the handle 14 to provide improved user comfort and prevent slippage. The plurality of grip pads 28 may include a pair of top grip pads 30 coupled to the handle top side 16 proximal the handle first end 20 and the handle second end 22 and a pair of bottom grip pads 32 coupled to the handle bottom side 18 proximal the handle first end 20 and the handle second end 22. Each grip pad 28 may be ellipse-shaped for to provide an ergonomic shape and to receive either the user's thumb or forefinger. Each grip pad 28 may be rubberized for elastic resilience and/or textured to increase friction.

A first wrench head 34 is coupled to the handle 12. The first wrench head 34 may have a first neck portion 36 pivotably coupled to the handle first end 20. A first head portion 38 coupled to the first neck portion 36 is sized to a standard metric size. A second wrench head 40 is coupled to the handle 12. The second wrench head 40 has a second neck portion 42 pivotably coupled to the handle second end 22. A second head portion 44 coupled to the second neck portion 42 is sized to a standard SAE size.

Each of the first wrench head 34 and the second wrench head 40 may pivot between a parallel position lying parallel to the handle top side 16 and a perpendicular position lying perpendicular to the handle top side 16. Each of the first neck portion 36 and the second neck portion 42 may have a pair of ears 46 to receive an extension portion 48 of each of the handle first end 20 and the handle second end 22 and a pivot pin 50 extending through the pair of ears 46 and the extension portion 48.

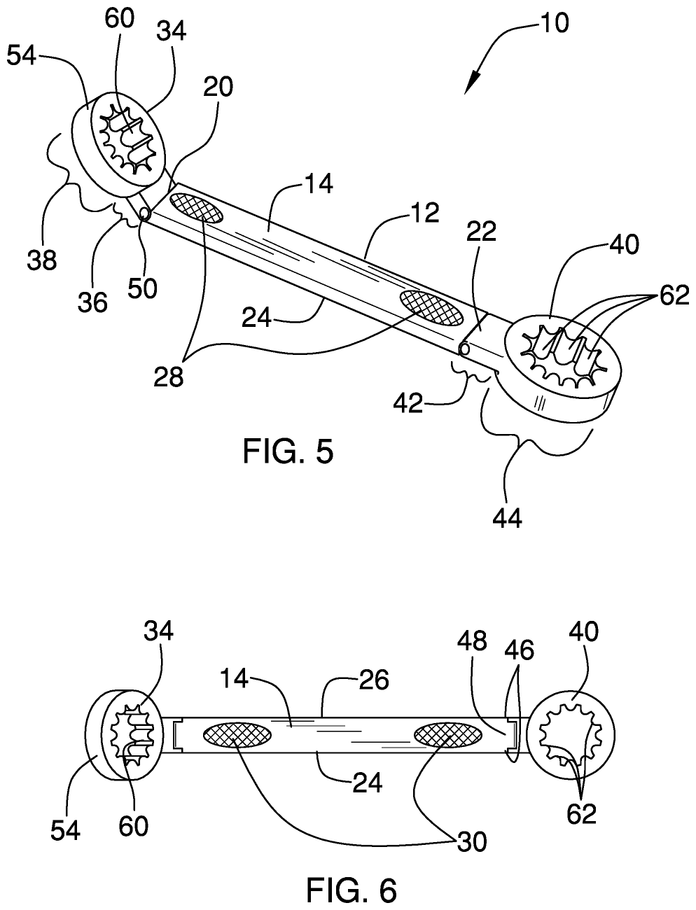

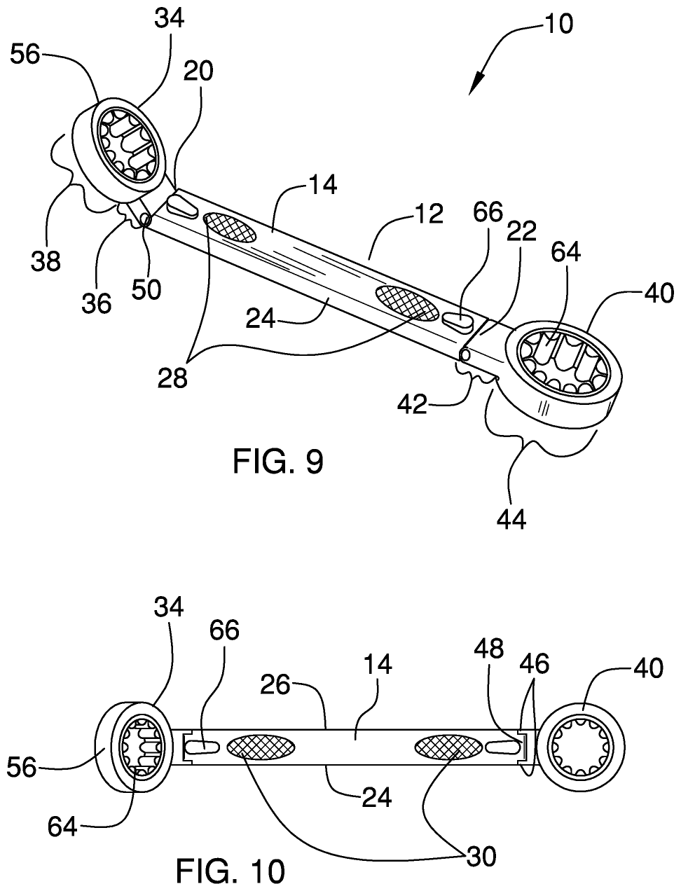

Each of the first wrench head 34 and the second wrench head 40 may be one of an open-end wrench head 52 as shown in FIGS. 1-4, a box end wrench head 54 as shown in FIGS. 5-8, or a ratcheting box end wrench head 56 as shown in FIGS. 9-12. The open-end wrench head 52 has a nut channel 58 extending within the first head portion 38 and the second head portion 44. The first head portion 38 and the second head portion 44 of the box end wrench head 54 are circular with a fixed nut aperture 60. The fixed nut aperture 60 has a plurality of splines 62 to secure a nut. The first head portion 38 and the second head portion 44 of the ratcheting box end wrench head 56 are also circular with a rotating splined ring 64 coupled therein. The first wrench head 34 and the second wrench head 40 of the ratcheting box end wrench heads 56 each have a directional switch 66 coupled to the handle top side 16. The directional switch 66 coupled adjacent the handle first end 20 is in operational communication with the first wrench head 34 and the directional switch 66 adjacent the second wrench head 40 is in operational communication with the second wrench head 40 to control the direction of the ratcheting motion of the respective rotating splined ring 64.

In use, the user secures the handle 14 and places either the first wrench head 34 or the second wrench head 40 onto a nut. He may then adjust the angle of the handle 14 relative the first wrench head 34 or the second wrench head 40 to fit within a confined space or may switch the orientation of the handle top side 16 and the handle bottom side 18 to prevent pivoting. The apparatus 10 may then be used as a traditional wrench.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pivoting head wrench apparatus comprising:
a handle having a handle top side, a handle bottom side, a handle first end, a handle second end, a handle front edge, and a handle back edge;
a first wrench head coupled to the handle, the first wrench head being pivotably coupled to the handle first end, the first wrench head being sized to a standard metric size; and
a second wrench head coupled to the handle, the second wrench head being pivotably coupled to the handle second end, the second wrench head being sized to a standard SAE size.

2. The pivoting head wrench apparatus of claim 1 further comprising each of the first wrench head and the second wrench head pivoting between a parallel position lying parallel to the handle top side and a perpendicular position lying perpendicular to the handle top side.

3. The pivoting head wrench apparatus of claim 1 further comprising each of the first wrench head and the second wrench head being an open-end wrench head.

4. The pivoting head wrench apparatus of claim 1 further comprising each of the first wrench head and the second wrench head being a box end wrench head.

5. The pivoting head wrench apparatus of claim 1 further comprising each of the first wrench head and the second wrench head being a ratcheting box end wrench head.

6. The pivoting head wrench apparatus of claim 5 further comprising each of the first wrench head and the second wrench head having a directional switch coupled to the handle top side, the directional switch adjacent the handle first end being in operational communication with the first wrench head and the directional switch adjacent the second wrench head being in operational communication with the second wrench head.

7. The pivoting head wrench apparatus of claim 1 further comprising a plurality of grip pads coupled to the handle.

8. The pivoting head wrench apparatus of claim 1 further comprising the plurality of grip pads including a pair of top grip pads coupled to the handle top side proximal the handle first end and the handle second end and a pair of bottom grip pads coupled to the handle bottom side proximal the handle first end and the handle second end.

9. The pivoting head wrench apparatus of claim 1 further comprising each grip pad being ellipse-shaped.

10. The pivoting head wrench apparatus of claim 1 further comprising each of the first wrench head and the second wrench head having a first neck portion and a second neck portion pivotably coupled to the handle first end and the handle second end, respectively.

11. A pivoting head wrench apparatus comprising:
a handle having a handle top side, a handle bottom side, a handle first end, a handle second end, a handle front edge, and a handle back edge;
a plurality of grip pads coupled to the handle, the plurality of grip pads including a pair of top grip pads coupled to the handle top side proximal the handle first end and the handle second end and a pair of bottom grip pads coupled to the handle bottom side proximal the handle first end and the handle second end, each grip pad being ellipse-shaped;
a first wrench head coupled to the handle, the first wrench head having a first neck portion pivotably coupled to the handle first end, the first wrench head being sized to a standard metric size; and
a second wrench head coupled to the handle, the second wrench head having a second neck portion pivotably coupled to the handle second end, the second wrench head being sized to a standard SAE size;
each of the first wrench head and the second wrench head pivoting between a parallel position lying parallel to the handle top side and a perpendicular position lying perpendicular to the handle top side, each of the first wrench head and the second wrench head being one of an open-end wrench head, a box end wrench head, or a ratcheting box end wrench head.
